(19) United States
(12) Patent Application Publication
(10) Pub. No.: US 2007/0182531 A1
(43) Pub. Date: Aug. 9, 2007

(54) Method for measurement, storage and provision of key tire data of a motor vehicle

(75) Inventor: Gregor Kuchler, Thalmassing (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Siemens AG

(21) Appl. No.: 11/334,196

(22) Filed: Jan. 17, 2006

(51) Int. Cl. B60Q 1/00; B60C 23/02

(52) U.S. Cl. 340/438; 340/442

(57) ABSTRACT

A method for measurement, storage and provision of key tire data, uses sensors assigned to the individual tires, tire electronics units assigned to each tire, and a vehicle-side control unit in which all key tire data measured over the period of the use of a tire will be stored in an electrical memory unit of the associated tire electronics unit, with the tire electronics unit arranged on each tire a current tire mileage performance is determined, added to the existing, stored overall mileage performance and stored as new overall mileage performance in the memory unit, with a transmission unit arranged at each tire the stored key tire data and the overall mileage performance are transmitted to the vehicle-side evaluation unit, and the energy required for operation of the tire is obtained in each case from energy generators each assigned to a tire.

### TECHNICAL FIELD

The invention relates to a method for measurement, storage and provision of key tire data in accordance with the preamble of claim 1. Of the key tire data for which up-to-date measured values have a decisive influence on the safe driving behavior of motor vehicles, the tire mileage performance determined at the current time plays an important part since there are basic restrictions on tire mileage performance, through wear to the usable tread or the occurrence of structural damage to the tire for example.

### BACKGROUND

To determine the tire mileage performance on the motor vehicle the principle of radio transmission of the data determined to tire or wheel electronics or of estimating said data in the wheel or tire from the centrifugal acceleration is well known. However problems arise with these known methods with regard to the integrity of the data or the accuracy of the estimation respectively.

Sensors for detection of an at least partly constant external force field are frequently used for localization of wheel electronics. Sensors which might typically be considered suitable for such purposes include acceleration or shock sensors in conjunction with the gravitational field or magnetic field sensors in conjunction with earth's magnetic field. The prerequisite for the localization function is that the useful variable, e.g. the gravitational force, can be extracted with sufficient accuracy from the sum signal of the useful and disturbance variables, e.g. centrifugal force. This is for example to be achieved by an essentially tangential arrangement of the acceleration sensor or by forming the derivation over time of the sum signal or through elimination of a constant offset.

With this type of sensor system or a similar sensor system the tire mileage performance can now be determined very precisely. During a period of the—periodic sensor signal the tire has completed precisely one revolution. With knowledge of the exact size of the tire, stored electronically in the tire electronics for example, the wheel electronics can automatically determine and store the tire mileage performance by simply counting the periods.

The disadvantage of the prior art is that the key tire data such as pressure and tire mileage performance are transferred by a wheel unit and stored in a vehicle-side evaluation unit but that this information is not transferred to the new vehicle when the tire is transferred to another vehicle. Systems which determine the mileage behavior in the motor vehicle and transmit it to the wheel electronics also fail when the tire is transferred to a vehicle not equipped for such purposes. This means that determination of the tire mileage performance does not work although the tire is being used, with the result that the data integrity cannot be ensured in this way.

### SUMMARY

The underlying object of the present invention is thus to provide a better method for storing and providing key tire data compared to the prior art.

In accordance with the invention this object can be achieved by a method for measurement, storage and provision of key tire data, using sensors assigned to the individual tires, tire electronics units assigned to each tire, and a vehicle-side control unit, the method comprising the steps of: storing all key tire data measured over the period of the use of a tire in an electrical memory unit of the associated tire electronics unit, with the tire electronics unit arranged on each tire, determining a current tire mileage performance, adding the current tire mileage performance to an existing stored overall mileage performance and storing a result of said adding as new overall mileage performance in the memory unit, with a transmission unit arranged at each tire, transmitting the stored key tire data and the overall tire mileage performance to a vehicle-side evaluation unit, and obtaining the energy required for operation of the tire electronics units from respective energy generators each assigned to a tire.

When the key tire data is measured, a tire pressure, a tire temperature, a tire speed and a time assigned to the tire speed of each tire can be measured. The tire mileage performance can be determined from a tire speed and an assigned time interval of each tire. A warning signal can be displayed in a motor vehicle if a defined overall mileage performance of a tire is exceeded.

In accordance with the invention an energy generator is used which is a component of a tire-based electronics unit, to convert mechanical energy into electrical energy for the operation of the tire electronics. This energy generator either itself provides electrical power which changes periodically with the rotation of the wheel or supplies the tire electronics with operating energy when the tire is turning. This ensures that a mileage performance counter always counts the tire mileage performance when the tire is in operation and is turning. The tire mileage performance is the number of complete tire revolutions in a specific period of time. The number of complete tire revolutions is described below as the tire speed. This prevents a tire, because of battery exhaustion or because it is installed on a vehicle without a system for transmission of mileage performance data, being operated without the mileage performance data being logged.

While the mileage performance is the core of the solution, it can also be expanded to a measurement and transmission of wheel angular speeds, i.e. to measurement of the mileage performance relative to circumference of the tire and time for a revolution.

The advantages of the solution described lie in the use of existing sensors, the simple and robust principle which can also be realized in low-cost controllers and state machines, as are currently generally used in wheel electronics, and in compatibility with current products. The function can for example be integrated as an add-on into existing products. A further advantage lies in the data integrity, with only a tire mileage performance measurement running independently in the wheel guaranteeing correct information about the mileage performance.

Further details and advantages of the invention are explained with reference to the enclosed Figures.

### BRIEF DESCRIPTION OF THE DRAWINGS

The figures show schematic diagrams of:

FIG. 1 a motor vehicle with tires; and

FIG. 2 a tire electronics unit.

In the description of the preferred embodiment of the present invention below the same reference symbols refer to the same or comparable components.

### DETAILED DESCRIPTION

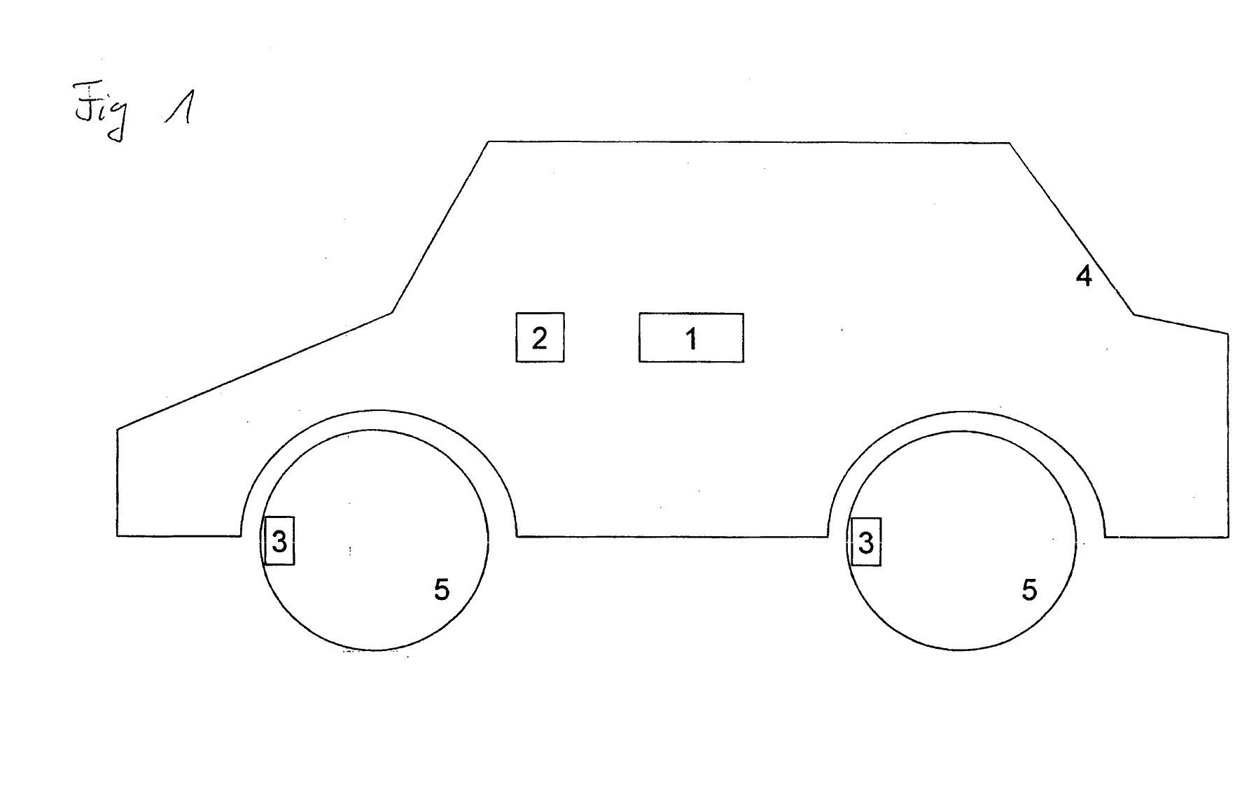

FIG. 1 shows the schematic diagram of a motor vehicle 4 with the associated vehicle tires 5. An electronics unit is arranged on each of the vehicle tires 5. A transmit and/or receive antenna, which preferably receives signals from the tire electronics 3, is arranged on the motor vehicle 4. During a synchronization of key tire data which is stored in a memory module 10 it is also possible to send data from a vehicle-side control unit 1 to the tire electronics unit 3.

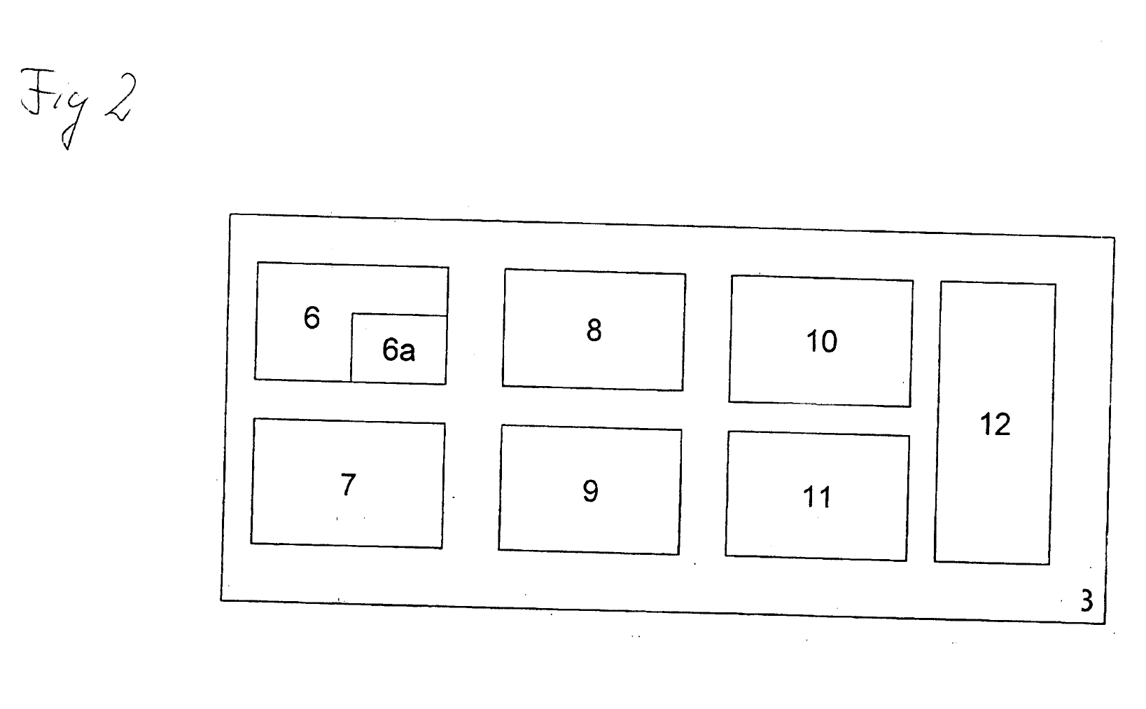

FIG. 2 shows a schematic diagram of the layout of the tire electronics unit 13. The tire electronics unit includes an energy generator 6, which optionally includes an additional battery. The energy generator 6 for example converts the rotation energy of the tire into electrical energy for the tire electronics unit and stores it in an energy accumulator 7. The measurement of the key tire data, the determination of the tire mileage performance and the addition of the tire mileage performance as well as the storage in the memory unit 10 is controlled in a scheduler 8. The sensors 9 measure the key tire data, such as tire pressure, tire temperature, tire speed and a time assigned to the tire speed for example. The key tire data is stored in a non-volatile memory 10. Furthermore a communication unit 11 as well as an antenna 12 are arranged in the tire electronics unit 3, which sends the key tire data from the tire electronics unit 3 to the vehicle-side control unit 1.

The present invention is especially suitable for the measurement, storage and provision of key tire data.

1. A method for measurement, storage and provision of key tire data, using
sensors assigned to the individual tires,
tire electronics units assigned to each tire, and
a vehicle-side control unit,
the method comprising the steps of:
storing all key tire data measured over the period of the use of a tire in an electrical memory unit of the associated tire electronics unit,
with the tire electronics unit arranged on each tire, determining a current tire mileage performance, adding the current tire mileage performance to an existing stored overall mileage performance and storing a result of said adding as new overall mileage performance in the memory unit,
with a transmission unit arranged at each tire, transmitting the stored key tire data and the overall tire mileage performance to a vehicle-side evaluation unit,
and obtaining the energy required for operation of the tire electronics units from respective energy generators each assigned to a tire.

2. A method according to claim 1, wherein, when the key tire data is measured, a tire pressure, a tire temperature, a tire speed and a time assigned to the tire speed of each tire will be measured.

3. A method according to claim 1, wherein the tire mileage performance is determined from a tire speed and an assigned time interval of each tire.

4. A method according to claim 1, wherein a warning signal is displayed in a motor vehicle if a defined overall mileage performance of a tire is exceeded.

5. A method for measurement, storage, and provision of key tire data of a motor vehicle tire, the method comprising the steps of:
storing all key tire data measured over the period of the use of a tire in a memory unit in said tire,
determining a current tire mileage performance,
adding the current tire mileage performance to an existing stored overall mileage performance and storing a resulting new overall mileage performance in the memory unit,
transmitting the stored key tire data and the overall tire mileage performance to a vehicle-side evaluation unit,
and obtaining the energy required for operation of the memory unit from an energy generator within said tire.

6. A method according to claim 1, wherein, when the key tire data is measured, a tire pressure, a tire temperature, a tire speed and a time assigned to the tire speed of each tire will be measured.

7. A method according to claim 1, wherein the tire mileage performance is determined from a tire speed and an assigned time interval of each tire.

8. A method according to claim 1, wherein a warning signal is displayed in a motor vehicle if a defined overall mileage performance of a tire is exceeded.

9. A motor vehicle tire, comprising:
an electronic unit comprising a memory unit for storing all key tire data measured over the period of the use of a tire,
means for determining a current tire mileage performance,
means for adding the current tire mileage performance to an existing stored overall mileage performance and for storing a resulting new overall mileage performance in the memory unit,
a transmitter coupled with said electronic unit for transmitting the stored key tire data and the overall tire mileage performance to a vehicle-side evaluation unit,
an energy generator within said tire coupled with said electronic unit.

10. A tire according to claim 1, comprising means to measure a tire pressure, a tire temperature, a tire speed and a time assigned to the tire speed of the tire.

11. A tire according to claim 1, wherein the tire mileage performance is determined from a tire speed and an assigned time interval of each tire.

12. A vehicle comprising a tire according to claim 1, comprising means to display a warning signal if a defined overall mileage performance of a tire is exceeded.
